(19) United States
(12) Patent Application Publication
(10) Pub. No.: US 2006/0207182 A1
(43) Pub. Date: Sep. 21, 2006

(54) Interlocking mechanism for a window or the like

(76) Inventor: Remi Emiel Van Parys, Waregem (BE)

Correspondence Address: BACON & THOMAS, PLLC, 625 SLATERS LANE, FOURTH FLOOR, ALEXANDRIA, VA, 22314, US

(21) Appl. No.: 11/354,097

(22) Filed: Feb. 15, 2006

(30) Foreign Application Priority Data
Feb. 17, 2005 (BE) 2005/0087

(51) Int. Cl. E05D 15/52

(52) U.S. Cl. 49/192

(57) ABSTRACT

Interlocking mechanism for a window or the like which consists of two window parts, in particular a fixed frame (3) and a wing (4) which is hinge-mounted in the fixed frame (3), whereby the fixed frame (3) and the wing (4) each comprise a ledge with jambs (5,7) and joists (6,8), characterised in that the interlocking mechanism (2) consists of at least one pin (14) which can be axially moved in a longitudinal guide (9) in a jamb (6) or joist (8) on the outer perimeter of the wing (4), and which can extend at least partly past the far end of the jamb (6) or joist (8) concerned in an extreme position.

The present invention concerns an interlocking mechanism for a window or the like, in particular an interlock of what is called the burglar retarding type.

It is known to equip side-hung and/or tilting windows with an interlocking mechanism which consists of one or several laths provided in a movable manner in guides on the outer perimeter of a wing on the one hand, whereby one or several crosswise directed protrusions are each time provided on these laths, and of a metal or plastic post on the inner perimeter of the fixed frame on the other hand, whereby this metal or plastic post is provided with safety hangers in which the above-mentioned protrusions can be retained in order to lock the wing in relation to the fixed frame.

A disadvantage of this known interlocking mechanism is that the above-mentioned protrusions can only have a restricted length, as these protrusions must fit between the wing and the fixed part of the window in order to be able to open and close the window.

This restricted length of the protrusions is disadvantageous, however, as they can only mesh behind the edges of the security hangers over a restricted length, such that, with relatively little effort, they can be forced out of the security hangers, diagonally to the windows, and as a result of which it is relatively easy, for example for burglars, to open the window.

Another disadvantage is that the protrusions cannot simply be provided at the angular points of the wing, such that, when breaking open the window with a crow bar, for example, it is possible to obtain a relatively large leverage between the closing side of the window and the above-mentioned protrusions, which, consequently, can be easily forced.

The present invention aims to remedy one or several of the above-mentioned and other disadvantages.

To this end, the present invention concerns an interlocking mechanism for a window or the like which consists of two window parts, in particular a fixed frame and a wing which is hinge-mounted in the fixed frame, whereby the fixed frame and the wing each comprise a ledge with jambs and joists, characterised in that the interlocking mechanism consists of at least one pin which can be axially moved in a longitudinal guide in a jamb or joist on the outer perimeter of the wing, and which can extend at least partly past the far end of the jamb or joist concerned in an extreme position.

An advantage of an interlocking mechanism according to the present invention is that the length of the above-mentioned pin can be selected relatively large, such that a good securing of the pin in the fixed frame can be obtained.

Moreover, the above-mentioned pin can have such a length that, in an extreme position, it can reach for example into the wall in which the window is provided, such that the interlock of the window can be compared to the interlock of a door on which locking pins are provided on the inside which can be pushed in a hole in the floor concerned.

Another advantage of the interlocking mechanism according to the invention is that the position of the pins makes it possible to lock the window at the angular points of the wing, such that it is impossible to create a leverage between the closing side of the wing and the actual pins, as a result of which forcing the window becomes difficult and a burglar retarding effect is obtained.

In order to better explain the characteristics of the invention, the following preferred embodiments of an interlocking mechanism according to the invention are described as an example only without being limitative in any way, with reference to the accompanying drawings, in which:

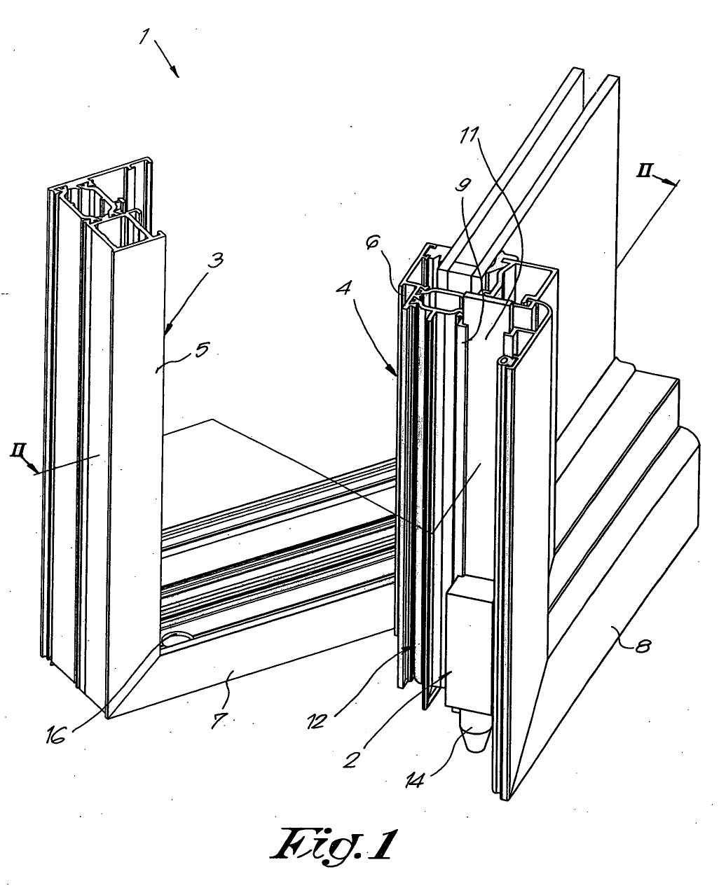

FIG. 1 is a view in perspective of a part of a window which is equipped with an interlocking mechanism according to the invention;

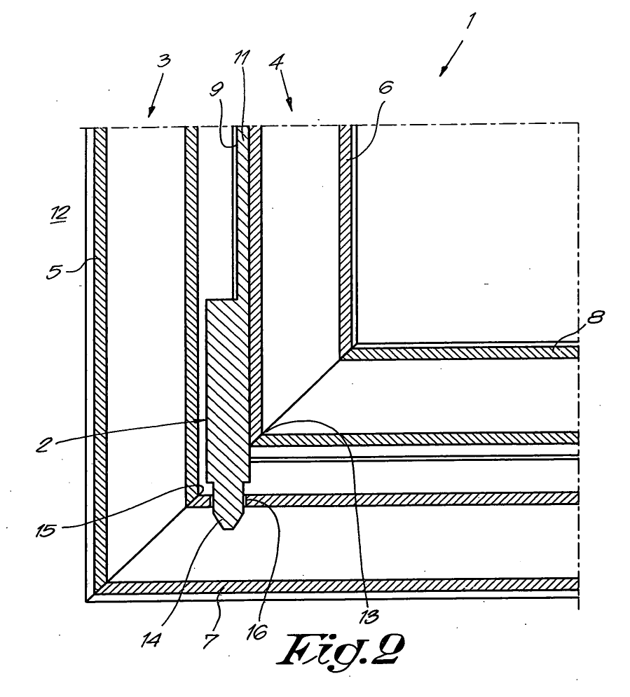

FIG. 2 represents a section according to line II-II in FIG. 1 to a larger scale;

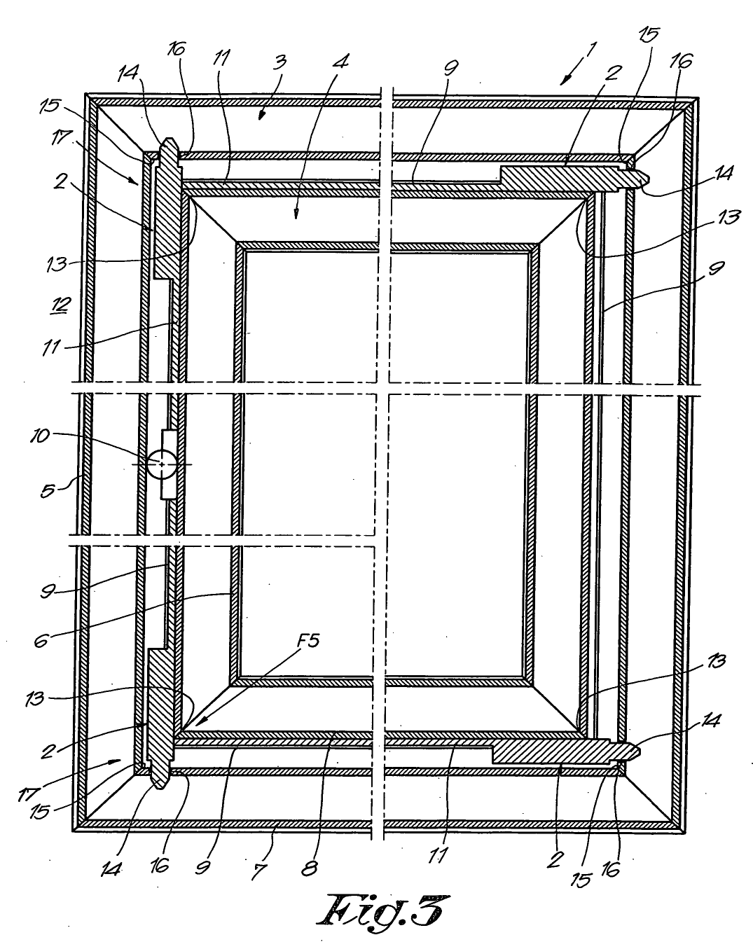

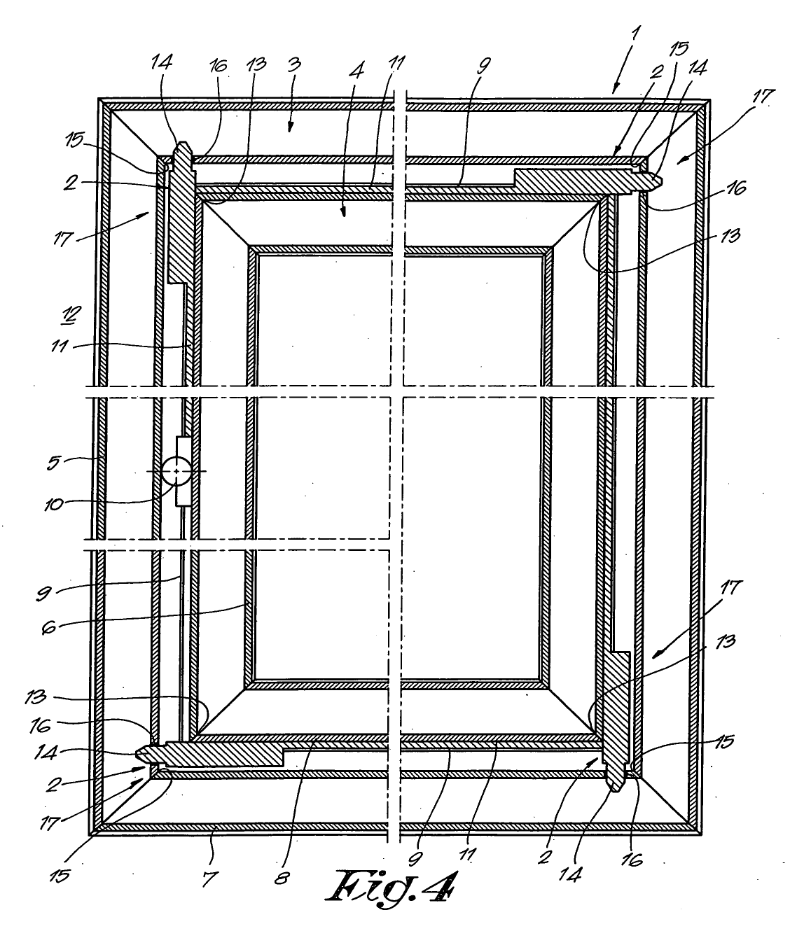

FIGS. 3 and 4 each represent a variant of an interlocking mechanism according to the invention;

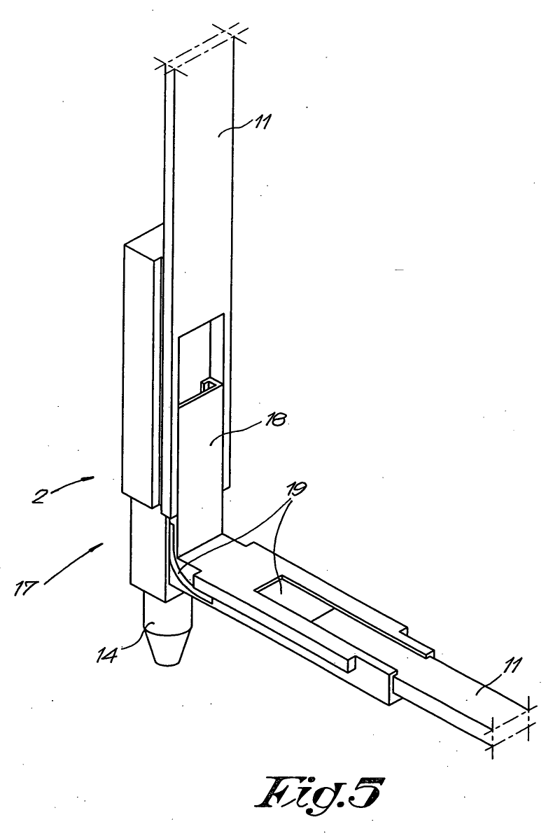

FIG. 5 represents the part indicated in FIG. 3 by F5 to a larger scale;

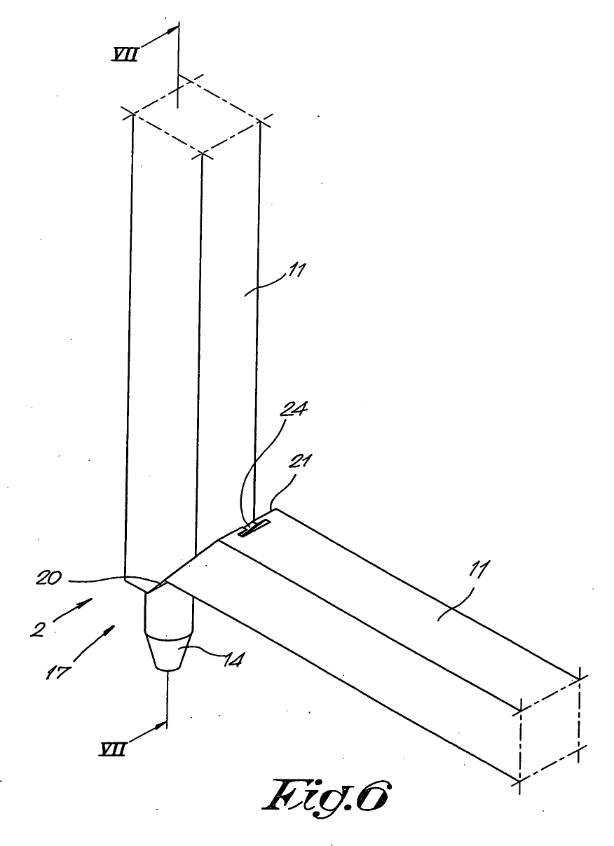

FIG. 6 represents a variant of FIG. 5;

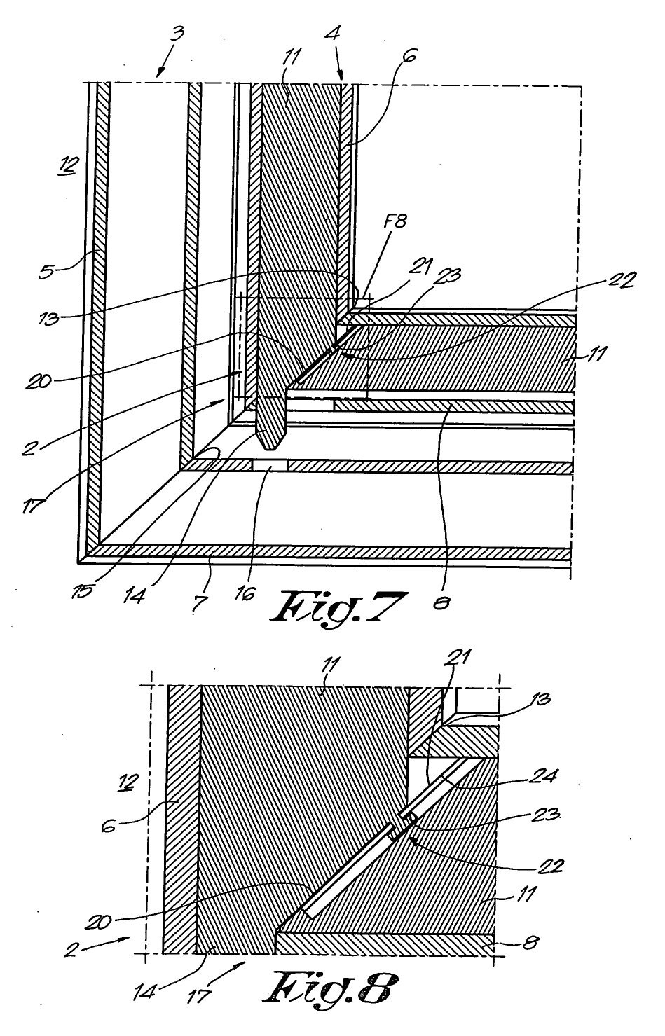

FIG. 7 represents a section according to line VII-VII in FIG. 6;

FIG. 8 represents the part indicated by F8 in FIG. 7 to a larger scale.

FIG. 1 is a view in perspective of a part of a window 1 which is equipped with an interlocking mechanism 2 according to the invention.

The window 1, which can be a side-hung window as well as a side-hung/tilting window, a tilting/side-hung window or a tilting window, consists, as is known, of a fixed frame 3 in which a wing 4 is hinge-mounted, whereby the fixed frame 3 as well as the wing 4 are formed of a ledge of jambs 5, 6 respectively, and joists 7, 8 respectively.

In the above-mentioned jambs 6 and joists 8, on the outer perimeter of the wing 4, are provided longitudinal guides 9.

The interlocking mechanism 2 according to the invention mainly consists of an operating mechanism 10 which is preferably provided on the wing 4 in the form of a crank or the like, and which works in conjunction with a lath 11 in a manner which is known to the craftsman, which lath can move in the above-mentioned longitudinal guide 9 in the jamb 6, on the closing side 12 of the wing 4.

According to the invention, on the far end of this lath 11, at an angle 13 of the wing 4, is fixed a pin 14 which extends longitudinally to past the far end thereof.

In a corresponding angle 15 of the fixed frame 3, on the inner perimeter, is provided a hole 16 with which the above-mentioned pin 14 can co-operate.

The working of the above-described interlocking mechanism 2 according to the invention is simple and as follows.

When the window 1 is locked, the lath 11 is situated in an extreme position, whereby the pin 14 partly extends past the far end of the jamb 6 concerned and is secured in the above-mentioned hole 16 in the fixed frame 3.

In order to open the window 1, one only has to handle or activate the known operating mechanism 10 on which the lath 11 is pushed in the longitudinal guide 9 in a direction whereby the pin 14 is pulled out of the above-mentioned hole 16.

Once the pin 14 has been pulled out of the hole 16, the window 1 can be opened by means of a hinge movement of the wing 4 in relation to the fixed frame 3.

In order to lock the window 1 again, after it has been closed, the operating mechanism 10 must be handled, such that the lath 11 is shifted towards the angle 13 of the wing 4, whereby the pin 14 is brought into the hole 16 and the window is thus locked.

It is clear that the interlocking mechanism 2 according to the invention can be made with several pins 14 which are each provided at a different angle 13 of the wing 4, and which can be each secured in a corresponding hole 16 in the fixed frame 3.

FIGS. 3 and 4 represent two variants whereby four pins 14 are in this case provided which are each provided on a far end of a corresponding lath 11. In the variant represented in FIG. 3, the operating mechanism 10 is coupled to different laths 11 which can each be shifted in a corresponding longitudinal guide 9 and which extend towards two adjacent angular points 13 of the wing 4.

Both laths 11 are provided with an above-mentioned pin 14 on their free ends on the one hand, and they are coupled to a respective angle drive 17 which is represented in greater detail in FIG. 5.

Each angle drive 17 mainly consists of a guide 18 tracing a right angle in this case, and which is fixed around the angle 13 on the outer perimeter of the wing 4.

In the above-mentioned guide 18 is provided a flexible metal lath 19 in a slidable manner, which is coupled with one far end to the above-mentioned lath 11 and which is coupled with its other far end to a lath 11 in a longitudinal guide 9 of the jamb 6 or joist 8 which is adjacent to the jamb 6 or joist 8 in which the operating mechanism 10 is provided.

Such an angle drive 17 is known in the field of window interlocking, and it is not further described in detail.

FIG. 4 represents another variant of an interlocking mechanism according to the invention, whereby four pins 14 are applied which are provided on laths 11 and which are all mutually connected by means of an angle drive 17 as mentioned above.

As is represented in FIG. 4, the latter variant is advantageous in that each of the pins 14 can be secured in a hole 16, each time in another jamb 5 or joist 7 of the fixed post 3, as a result of which, in case of a lateral pressure on the locked window 1, this pressure will be evenly distributed over the fixed frame 3, which can not so easily be distorted then.

FIGS. 6, 7 and 8 represent a variant of the above-mentioned angle drive 17, whereby two adjacent laths 11 have been mitred and are coupled to each other at their corresponding slanting sides 20-21 by means of a tap 22 with a thickened head 23 which is fixed to one slanting side 20 and which is secured in a rail-shaped guide 24 in which its head 23 can slide, provided in the slanting side 21 of the other lath 11.

It is clear that the length of one or several pins 14 can strongly vary, whereby these pins 14, in heavy embodiments, can have a length which makes it possible to move the pins 14 through the entire fixed frame 3 and to secure them in a hole in a wall in which the window 1 is provided, as a result of which the locking of the pins 14 is very efficient.

It is also possible to provide an adapter on the inner perimeter of the fixed frame 3 in which the hole 16 is provided, without providing a hole in the fixed frame 3 itself.

Finally, it should be noted that when applying one or several so-called insert corner pieces in the ledge of the fixed frame 3, as is known when manufacturing aluminium windows, the hole 16 is preferably provided partly in the corresponding insert corner piece, such that the edges of each hole 16 are not only formed by the material of the ledge of the fixed frame 3, which usually consists of several hollow cylinders, but that also the material of the insert corner piece surrounds the pins 14, as a result of which the locking of these pins 14 is more resistant against lateral pressure and, as a consequence, is better protected against burglary.

The present invention is by no means limited to the embodiments given above and represented in the accompanying drawings; on the contrary, such an interlocking mechanism according to the invention for a window or the like can be made according to many different variants while still remaining within the scope of the invention.

1. Interlocking mechanism for a window or the like comprising two window parts, said window parts including a fixed frame and a wing which is hinge-mounted in the fixed frame, said fixed frame and the wing each comprising a ledge with jambs and joists, wherein the interlocking mechanism comprises at least one pin which is axially movable in a longitudinal guide in a jamb or joist on the outer perimeter of the wing, and which is extendable at least partly past the far end of the jamb or joist at a fully extended position.

2. Interlocking mechanism according to claim 1, wherein at least one pin is fixed to a lath which can be moved in said longitudinal guide on the outer perimeter of the wing and which is coupled to an operating mechanism in order to lock the window.

3. Interlocking mechanism according to claim 1, wherein in the inner perimeter of the fixed frame, in the ledge, is provided a hole in which the pin is secured in a locked position of the window.

4. Interlocking mechanism according to claim 1, including an adapter fixed to an inner perimeter of the fixed frame, said adapter including a hole in which said pin is secured in a locked position of the window.

5. Interlocking mechanism according to claim 1, including at least three pins which are each axially movable in a longitudinal guide on the outer perimeter of a different jamb or joist of the wing.

6. Interlocking mechanism according to claim 5, wherein the pins are provided on mutually connected laths which are movable in the longitudinal guides on the outer perimeter of the wing.

7. Interlocking mechanism according to claim 6, wherein the different laths are mutually connected at their far ends by means of a lath made of flexible metal which can slide in a guide which is fixed to a respective corner of the wing.

8. Interlocking mechanism according to claim 6, wherein the laths (II) are mitred at the corners of the wing and are coupled to one another with their slanting sides.

9. Interlocking mechanism according to claim 3, wherein the hole is bored through the entire fixed frame into a wall in which the window is provided.
